(19) United States
(12) Patent Application Publication
(10) Pub. No.: US 2024/0041676 A1
(43) Pub. Date: Feb. 8, 2024

(54) BATHING APPARATUS

(71) Applicant: Thelma Rowena LIVERPOOL, Bronx, NY (US)

(72) Inventor: Thelma Rowena LIVERPOOL, Bronx, NY (US)

(21) Appl. No.: 18/491,423

(22) Filed: Oct. 20, 2023

Related U.S. Application Data
(63) Continuation of application No. PCT/IB2022/000816, filed on Mar. 17, 2022.
Application No. PCT/IB2022/000816 is a continuation-in-part of application No. 16/947,393, filed on Jul. 30, 2020, now Pat. No. 11,806,268.
(60) Provisional application No. 62/921,926, filed on Jul. 15, 2019.

(51) Int. Cl. A61G 7/00

(52) U.S. Cl. CPC A61G 7/0005

(57) ABSTRACT

Improved bathing apparatus and their conformations. The improved bathing apparatus includes descriptions of efficient methods used in bathing bedridden persons without the need to move them from the bed. The process will include devices used in collection of body waste generated by bedridden individuals. Since cleanliness of bedridden individuals is paramount to continuing health as well as prevention of new infections, the devices are converted to a secondary use for bathing since a conduit can also be used for drainage of wastewater from showering or bathing. An impermeable layer with a spout leading into the conduit is placed under the patient. The wastewater generated can be collected for disposal or directed to a drainage system. Several iterations of the bath system are described, presenting a choice for the user depending on conformations of and attachments to the bed. In all conformations, the drainage outlet can be stoppered to generate a pool of water when needed.

### PRIORITY

The application is a division of U.S. patent application Ser. No. 16/947,393 filed on 30 Jul. 2020 and published on 21 Jan. 2021 as US-2021-0015655-A1; additionally, US national stage application No. PCT/US2021/016093 with priority date 30 Jul. 2020, which was published on Feb. 3, 2022, under No. WO 2022/025983; both of which applications are incorporated by reference into this application as if fully set forth herein.

### BACKGROUND

Bathing a bedridden patient is a time-consuming task, usually involving two individuals who will manipulate the patient into a wheelchair with the assistance of a hoist or lift. The patient is then taken to the bathroom and transferred to a bath chair or other such container. After the bath, the process is reversed. There is substantial time spent in this process and more than one individual, as well as hoists and/or lifts, are required. This is problematic for individuals who have sole care of the patient, and it is increasingly difficult in a homecare environment Cleanliness of the skin in important for general health but also critical for the prevention of bed sores and other ailments which may develop. Our invention as described in the publications listed, proposed uses of a system for body waste collection and for bathing-in-place. In the current PCT application, we further define methods for use in carrying out the bathing activity focusing on homecare. In many cases, the caregivers are not professionals and can be a young person, family member, friend, working parent or an elderly spouse. Trained helpers may be available for a limited period, representing an additional cost. For this reason, the intent of our invention is to provide a system, which is simple to use, clean and reassemble thereby saving time, physical effort, and expense. Activities such as lifting the patient and transporting them to a different location is reduced.

Several assumptions are made in developing the concept: a. in all cases the upper section of the bed (head area) can be elevated for comfort and safety of the patient. The bed may also be sectional and can be easily manipulated; b. the bed is assumed to be a single bed—39 inches×75 inches (99 cm×190.5 cm) in dimension. It is understood that beds used in hospitals, institutions and those supplied for homecare may vary from these parameters; c. the thickness of mattresses varies greatly and is shown to be between 4 inches and 13 inches (10.2 cm to 33 cm); the thinner mattresses are usually leased for home use; d. the impermeable sheet or cover used in the bath process will also act as a protection preventing damage to the mattress during the bath process.

The simplest iteration of a bath apparatus is represented by an impermeable bath sheet with an exit spout leading into a conduit, with the sides of the sheet elevated to form an enclosure in which a patient can be bathed. The sheet can be supported by any of the following (bed) structures:
a. Full length side rails and a foot rail
b. Partial side rails and a foot rail
c. Full length side rails
d. Elevation of both head and foot sections of the bed
e. Physical modification of the bed frame to provide support examples of which are shown in FIG. 6A and FIG. 6B.

A variety of designs and materials comprising the bath enclosure are possible. In all cases, the primary requirements are flexibility and toughness, so that the material is not easily torn and protects the underlying mattress.

The second format will highlight the usefulness of the mattress protection layer in forming the bath enclosures. They are useful since they are already in place, and when modified as shown (FIG. 7c), require only the removal of top bedding to transform into a bath enclosure. When a shallow bath is required, a stopper is used to cause pooling by blocking the entry to the conduit. After completing the bathing process, and the water is drained, the surface is easily cleaned and dried, and the device is returned to the role of mattress protector. The comfort of the patient and advantages to the caregiver are primary goals. Benefits to the caregiver include easier and more efficient care of the patient, less physical work, reduced cost of care and time saving. Successful implementation of the ideas and concepts will involve input from a wide field of consultants. Determination of medically approved dimensions for bed openings, as well as material specifications and manufacturing requirements will be finalized in consultation with medical personnel, nursing practitioners, industrial engineers, and scientists, and most importantly collaborations with bed manufacturers.

### BRIEF SUMMARY OF THE INVENTION

Bathing of bedridden individuals ranks as one of the most difficult tasks facing caregivers. The process is as previously described.

Our innovation will allow a bath or shower to occur without removing the individual from the bed. In this summary we expand on requirements for the varying formats of devices useful in the bathing process. The presence of the conduit affords the easy removal of the wastewater generated from baths and showers.

Training videos proliferate on the internet detailing the rituals required in the removal or change of bedding while a bedridden patient is not physically removed. The patient is rolled carefully to one half of the bed, replacements are inserted while the old materials are removed. The patient is then rolled onto the clean section and the process of removal and replacement is completed. Utilizing these same techniques, the bath sheet (201,301) is placed under the patient with the spout inserted into the waste conduit. The flexible impermeable material is elevated to form the enclosure when supported as by bed rails or elevated regions of the bed.

An enclosure resulting from the bath sheet being draped over the bed rails and foot rail is envisioned on drawing 3/10. The elevation of the upper and lower sections of the bed is depicted on drawing 2/10. An enclosure is formed as previously described. Modifications to the physical structure of the bed will allow draping of the bath sheet (FIG. 6A, FIG. 6B). The figures represent elements which will add height to the corners of the bed, so that the bath sheet can be draped and supported.

A protective bed cover can be modified as shown to form an enclosure (FIG. 7C, FIG. 7D, FIG. 8) while a third concept envisions a merger of the waste conduit and a mattress protector (FIG. 9) simplifying the entire process. These two approaches will require only the removal of bedding and elevation of the extra layer as demonstrated in FIG. 7D or lifting of the bed cover in FIG. 10B, to erect the enclosure. Careful planning can combine several activities—removal of soiled linen, the bath process, and inserting clean linen—which is a time-saving process.

### BRIEF SUMMARY OF THE DRAWINGS

FIG. 1A is a perspective of the system for collecting body waste of non-ambulatory patients; a collection device is incorporated into a bed.

FIG. 1B shows the device used in the collection of body waste management.

FIG. 2 shows a longitudinal section of the system used for in place bathing with elevation of head and foot sections of the bed. The role of the conduit is seen.

FIG. 3 shows a longitudinal cross section of the system used for in place bathing with head section elevated and foot rail in place.

FIG. 4 is an exploded view of the longitudinal cross section of components comprising the body waste collection unit.

FIG. 5A is a view of bathing device forming an enclosure.

FIG. 5B is a top view of the enclosure formed by bathing device.

FIG. 6A is a view of a supporting structure providing elevation.

FIG. 6B is a view of a second supporting structure providing elevation.

FIG. 7A is a partial longitudinal view of spout leading into a conduit.

FIG. 7B is a longitudinal cross section of a spouted mattress protector and conduit.

FIG. 7C is a longitudinal cross section of a modified mattress protection cover.

FIG. 7D is a partial section of the modification elevated to form an enclosure.

FIG. 8 is a longitudinal cross section of the enclosure formed by the modification of the mattress cover.

FIG. 9 is a partial longitudinal cross section of the combined structure of conduit and bed protection.

FIG. 10A is a longitudinal cross section of the combined conduit and mattress cover in place.

FIG. 10B is a longitudinal cross section of the enclosure formed by elevation of the sides of the mattress protector.

### DETAILED DESCRIPTION OF THE INVENTION

The following description should be read with reference to the drawings, in which like elements in different drawings are identically identified and preceded by the page number. The drawings which are not to scale depict our interpretation of a concept and are not intended to limit the scope of the invention. The description illustrates by way of example the principles of the invention. The description will clearly allow one skilled in the art to make and use the invention. The variations shown represent adaptations of the initial design concept which significantly simplify the equipment necessary to permit in-place bathing and demand less time and effort of the caregiver in carrying out their duties.

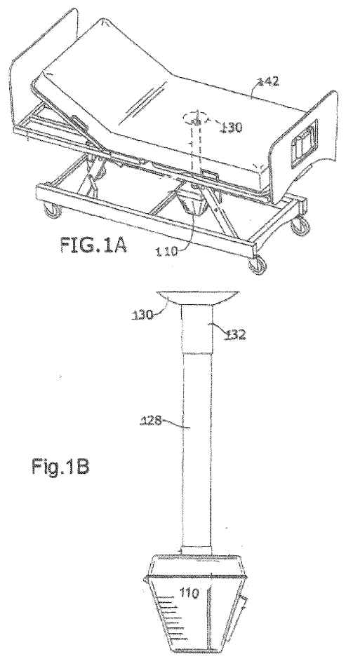

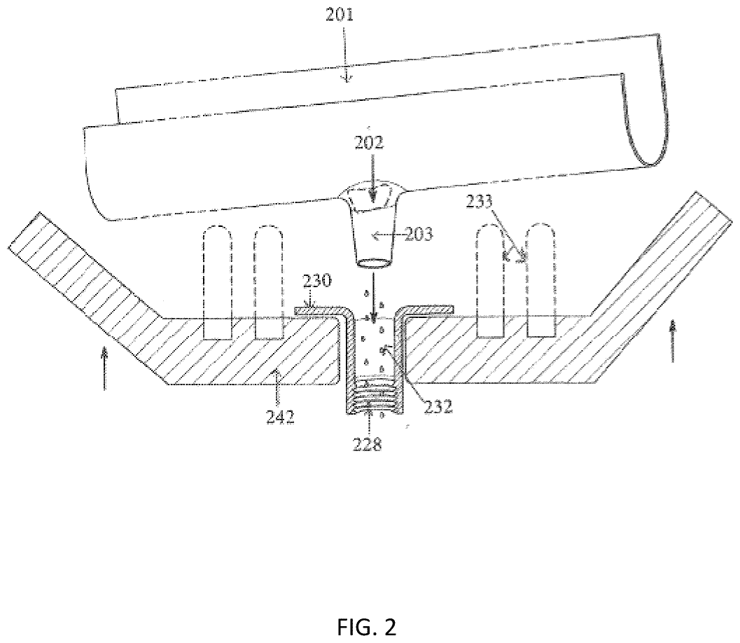

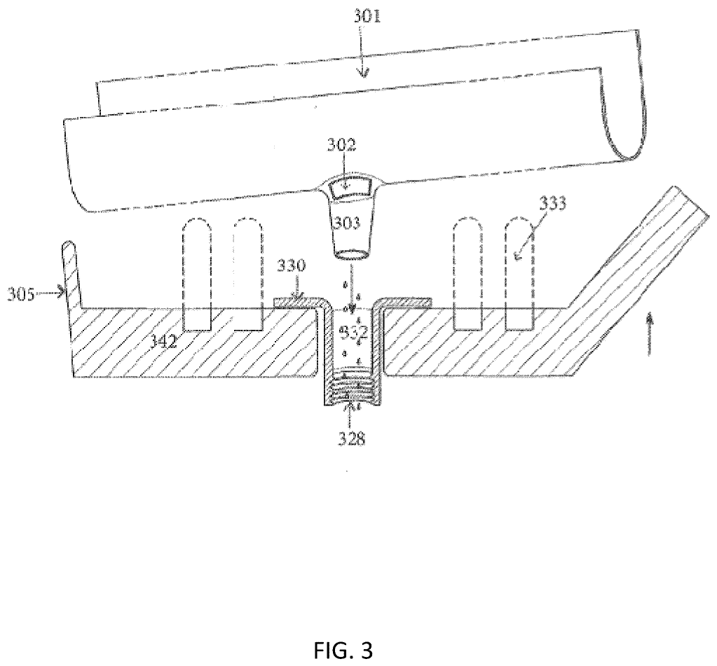

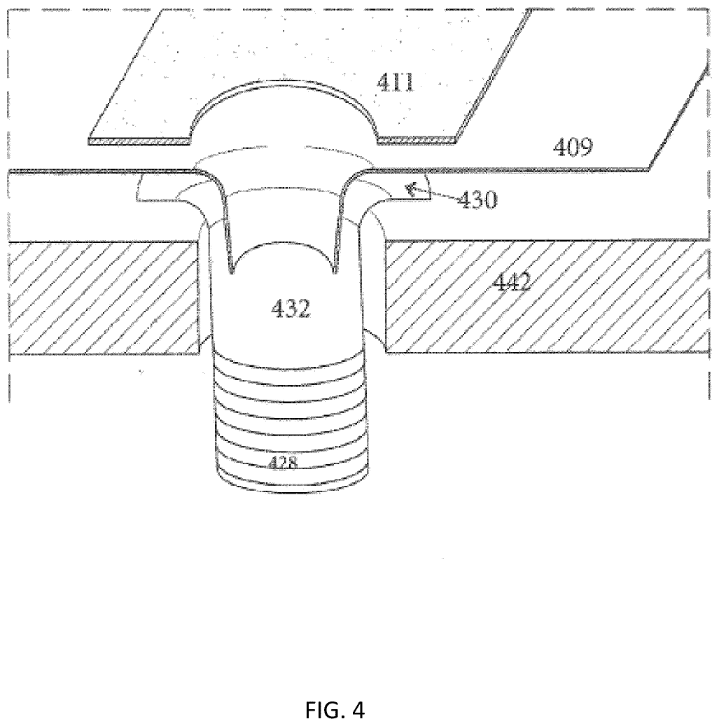

The waste system as described in priority publications is represented in FIG. 1A and FIG. 1B. The device shown in FIG. 1B has 3 sections: a support section inserted through the mattress serving as a conduit (132), a flexible section allowing position change for the collection apparatus (128), and a specialized collection unit (110). It is incorporated as into a bed shown in FIG. 1A. The simplicity of design is intentional since the ease of removal, cleanup and reinstallation is a hallmark of the invention. The intent is a significant decrease in the use of adult diapers while providing an improved method of collecting body waste. The device will also be useful in allowing a patient to be showered or bathed in bed without significant lifting of the patient. The most significant advantage to the caregiver is time saving, followed by the prevention of injury to both caregiver and patient from accidents.

In this application, we will focus on the innovations which will allow for bathing the individual in bed. The conduit for waste material (132) is inserted in the bed. The material of choice for the conduit is currently PVC piping normally used in plumbing fixtures. Alternatives are also being considered. The bed surface (142) is protected by a fitted impermeable cover (409) which protects the mattress and has a spout leading into the waste conduit (432). Above the bed protection layer, is a comfort layer (411) which has the requirement of wicking away moisture from the skin and can be easily removed or changed. The patient's buttocks will rest on this layer. The conduit for waste removal is also helpful in allowing some drainage. The conduit (432) leads to a flexible section (428) which has two functions: it leads to a specialized collector (110) which can be moved to a desired position, either under a bed or moved when a sample of the contents must be taken, or cleaning of the unit is necessary.

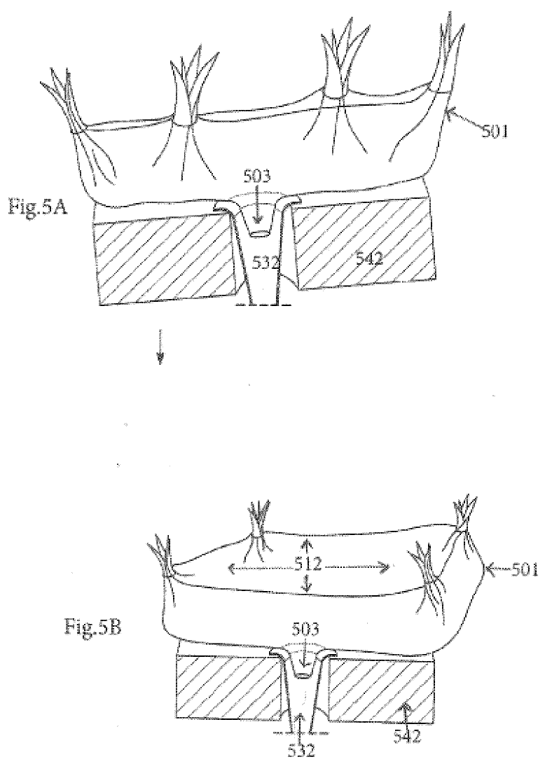

The focus of the rest of this description will be on the various iterations of the bathing devices. The use of a bath sheet (201,301) made of impermeable flexible fabric and having a spout (203, 303) which is directed into the conduit (232, 332, 432) is a simple solution. It is first placed under the patient as bed linen is removed. The mattress protector (409) can remain in place, but the bath sheet (201,301) can be used alone. The method of placing the patient on their side while changing bed linen, will also be used to position the bath sheet under the patient with the spout inserted into the conduit. It is necessary to elevate the head of the bed to a comfortable position, and the sheet is draped over side rails, foot rails or other supports as previously described. The draping of the sheet over these supports forms an enclosure, FIG. 5B. A list of supports for bath sheets and other types of enclosures is provided in Section above. An extended showerhead provides the source of water for a shower. If a bath is required, a stopper (202, 302) can block the flow of water through the conduit.

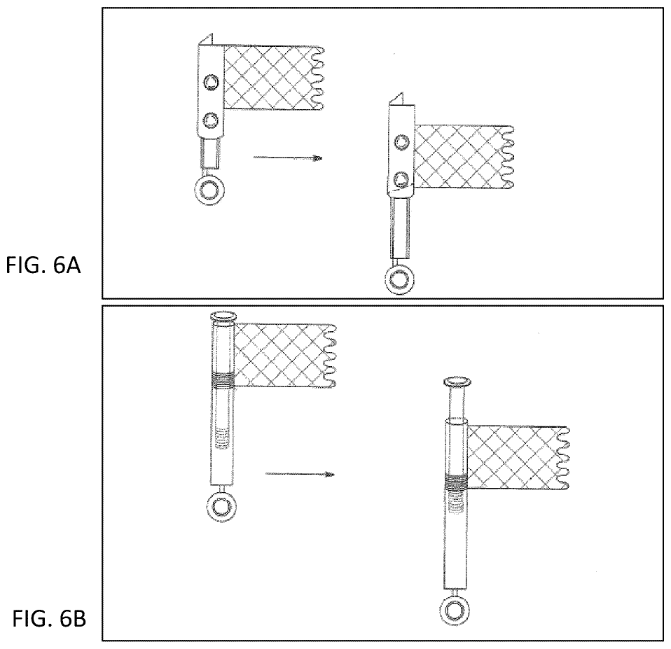

The sides of the bath sheet can be gathered as shown in FIG. 5A and FIG. 5B. prior to draping over the supports. This will prevent sagging and accidental spillage of water. Supports which can be designed into a bed where none exist are shown in FIG. 6A and FIG. 6B. These extensions can be built into the corners of beds as shown; they can be elevated when needed then returned to a normal position at the completion of the bath or shower.

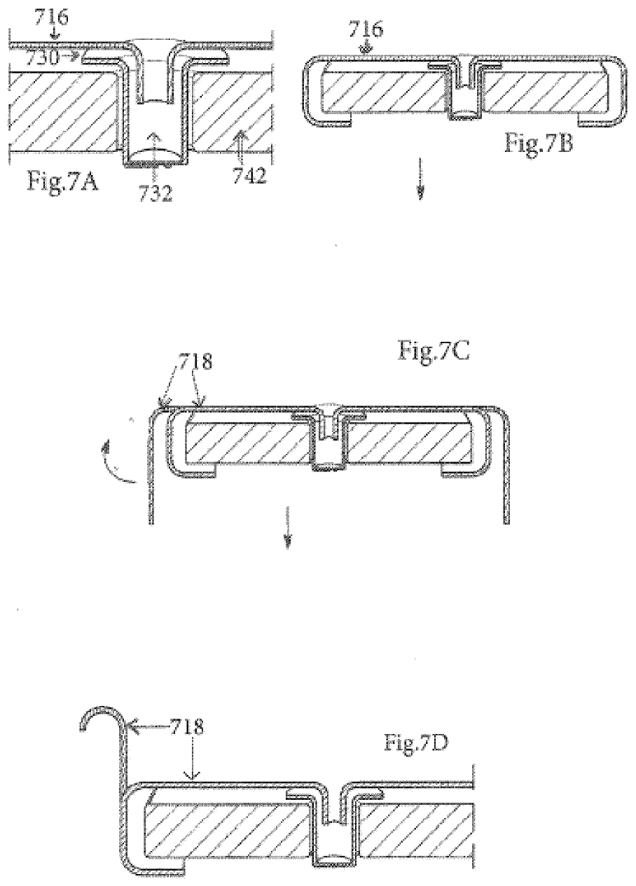

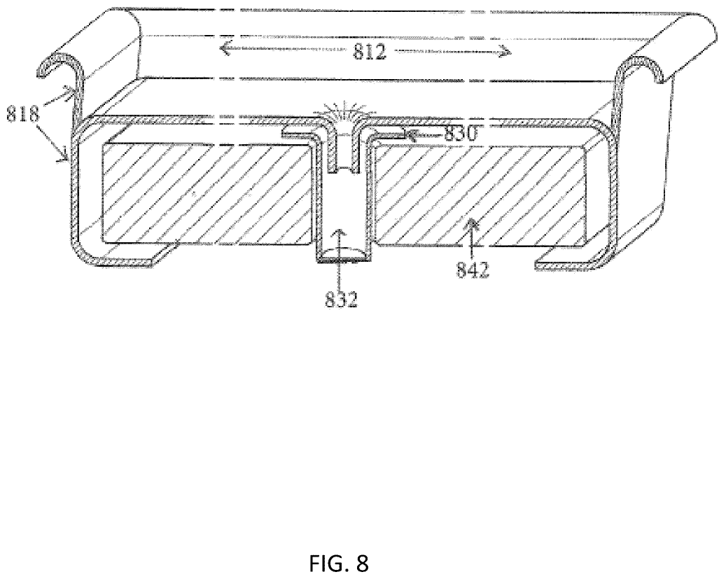

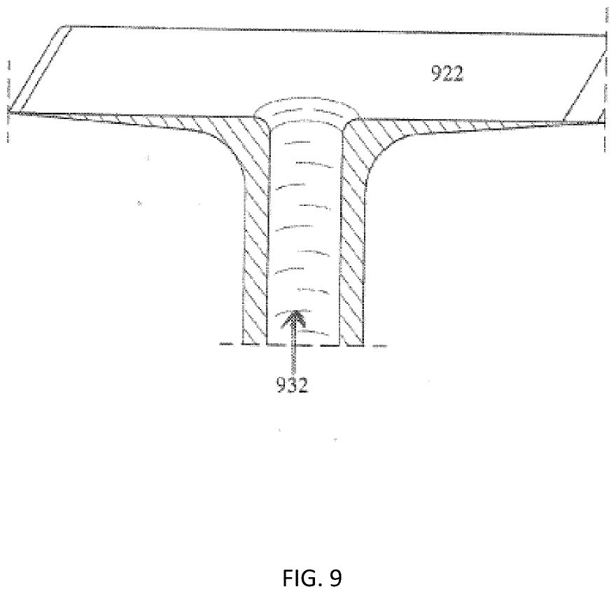

A second form of enclosure can be developed when a fitted mattress protector which has a spout leading into the conduit as shown in FIG. 7A (partial view) and FIG. 7B, is further modified by the addition of a layer of the same impermeable material which drapes as shown in FIG. 7C. The draped portion can be tucked beneath the mattress when not in use. When a bath is needed, linen is simply removed from the bed, the draped section is lifted and placed over supports as previously described, forming an enclosure shown in FIG. 8. Once the bath has been completed, the surface is wiped and dried, reverting to the role of mattress protector. The bed can then be made up as normally required.

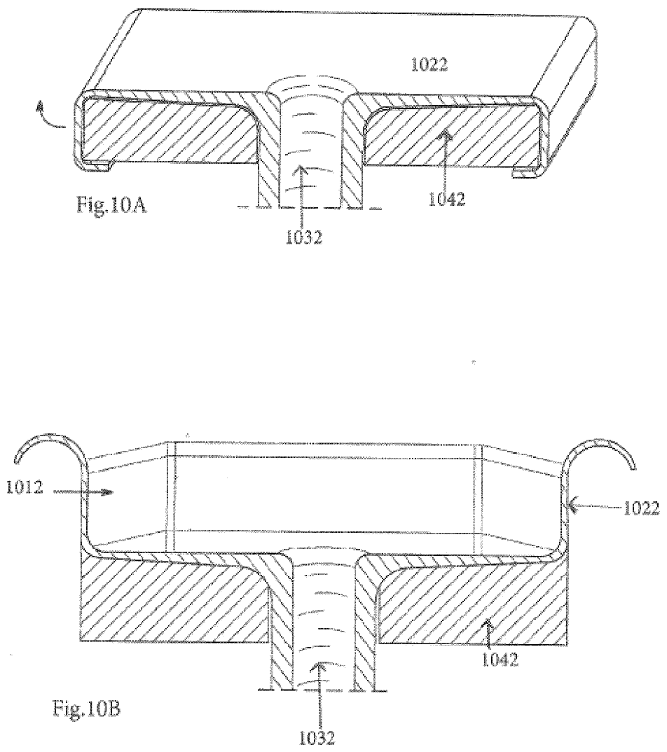

A third form of enclosure is envisioned when the conduit, bed cover and sides of the enclosure (1012) are formed from a single unit. This is shown in FIG. 10. This form is the most adaptable since the conduit can more easily be modified at the manufacturing stage to fit any thickness of mattress. Beds which are normally leased for the homecare market have mattresses which are thinner, and at the lower range of quality. All grades of bedding are adaptable to the incorporation of the innovations described, but we are currently focused on the homecare market. Consultations with polymer scientists, engineers and manufacturers are ongoing to generate working models of the prototypes. To generate the bed protector layer, the polymer can be extruded to form a thin flexible bed cover. The conduit can be prepared by a different method such as injection polymerization with parameters such as firmness and inflexibility which will allow placement within the mattress, in the place of PVC piping normally used. This method of preparation will allow for customization of the conduit based on the depth of the mattress; when merged with the bed cover section, a single item is formed which is easy to handle, as well as being easily cleaned and maintained. This confirmation will require unique methods of merging with the flexible region (128) different from earlier versions. Research is ongoing on possible new materials to be used so that performance of the unit as a waste collector is not impaired.

In all conformations, it is necessary that the flow of water or waste is not impeded when the flexible connector is angled or removed from a straight drop position directly under a bed. If a kink is formed in the flexible region, the flow of material can be stopped or slowed. We have identified connectors which will solve this problem. Connections to disposal units within a home sewer or wastewater system for non-infections body waste or wastewater is a desired step. Research in consultation with master plumbers to identify necessary accessories for this action is ongoing.

### INDUSTRIAL APPLICABILITY

The innovations described in this application apply to the healthcare industry, particularly to the care of individuals who are bedridden or unable to care for themselves. They are intended to help caregivers by demanding less time and effort as well as to improve the level of care provided to individuals cared for at home.

What is claimed is:

1. The formation of an enclosed area on a bed for use as a bath or shower.

2. The apparatus of claim 1 comprising an impermeable sheet with an exit spout which, when the sides are supported, form an enclosure.

3. The exit spout of claim 2 can be sealed by a stopper to provide an accumulation of liquids allowing for bath or soaking of a patient.

4. The exit spout of claim 2 allows a continuous flow of water resulting from a shower.

5. The exit spout of claim 2 will lead directly to a conduit allowing for natural drainage of any liquid as well as release of accumulated bath water.

6. Formation of an enclosure by using supports to elevate the sides of the impermeable sheet. Supports are identified—full length side rails, full length foot rails and a foot rails, partial side rails and a foot rail, elevation of head and foot sections of a bed simultaneously, physical modifications of the bed frame to provide support

7. The physical modifications of the bed frame allowing for support where none is available.

8. The support will consist of the addition of a panel attached to the external edge of the bed which can be elevated when needed; the addition of a screw type extension to a circular hollow region which can be adjusted to a desired height.

9. Forming an impermeable full mattress protector with a spout for disposal of waste and wastewater into a conduit.

10. An impermeable protective mattress cover with a spout and with an added layer of impermeable fabric around the perimeter of the bed dimension.

11. Forming an enclosure by elevating and supporting the added layer.

12. Forming a bath by closing the entry to the waste conduit.

13. Combination of a conduit and mattress protection in a single unit formed from industrial and medical grade polymers using injection molding and/or polymer extrusion processes.

14. The formation of an enclosure for bathing and/or showering by elevating and supporting the sides of the mattress protector.

15. The conduit in this iteration also acts as a spout permitting natural drainage, flow of water during a shower, drainage of water following a bath, drainage of any liquids.
